(19) United States
(12) Patent Application Publication
(10) Pub. No.: US 2018/0053164 A1
(43) Pub. Date: Feb. 22, 2018

(54) Method for Retail On-Line Account Opening With Early Warning Methodology

(71) Applicant: Branch Banking and Trust Company, Raleigh, NC (US)

(72) Inventors: Teresa Rose, Holly Springs, NC (US); Patricia Kinney, Cary, NC (US); Barbara Whorf, Raleigh, NC (US); Paal Kaperdal, Raleigh, NC (US); Douglas Joel Zickafoose, Raleigh, NC (US)

(73) Assignee: Branch Banking and Trust Company, Raleigh, NC (US)

(21) Appl. No.: 15/799,185

(22) Filed: Oct. 31, 2017

Related U.S. Application Data
(63) Continuation of application No. 14/750,326, filed on Jun. 25, 2015, now abandoned.
Application No. 14/750,326 is a continuation of application No. 12/561,118, filed on Sep. 16, 2009, now abandoned.
Application No. 12/561,118 is a continuation-in-part of application No. 12/540,179, filed on Aug. 12, 2009, now abandoned.
(60) Provisional application No. 61/088,267, filed on Aug. 12, 2008.
(60) Provisional application No. 61/088,229, filed on Aug. 12, 2008.
(60) Provisional application No. 61/088,239, filed on Aug. 12, 2008.
(60) Provisional application No. 61/097,381, filed on Sep. 16, 2008.
(60) Provisional application No. 61/097,375, filed on Sep. 16, 2008.

(51) Int. Cl. G06Q 20/10; G06Q 40/02; G06Q 30/02

(52) U.S. Cl. CPC G06Q 20/108; G06Q 40/02; G06Q 30/02

(57) ABSTRACT

A system and method for a retail customer interfacing with a financial institution through a computer network is presented. The method includes an early warning evaluation of the customer and/or entities associated with the customer to identify fraudster/abusers and prevent them from opening online accounts at the financial institution.

### RELATED AND CO-PENDING APPLICATIONS

This application is a continuation of and claims priority of co-pending non-provisional application entitled “Method for Retail On-Line Account Opening with Early Warning Methodology”, Ser. No. 14/750,326 filed 25 Jun. 2015, which application is a continuation of and claims priority of co-pending non-provisional application entitled “Method for Retail On-Line Account Opening with Early Warning Methodology”, Ser. No. 12/561,118 filed 16 Sep. 2009, which application is a continuation in part of and claims priority of co-pending non-provisional application entitled “System and Method for Retail Online Account”, Ser. No. 12/540,179 filed 12 Aug. 2009, which claims priority of provisional applications: “System and Method for Business Online Account Opening”, Ser. No. 61/088,267 filed 12 Aug. 2008; “System and Method for Retail Online Account”, Ser. No. 61/088,229 filed 12 Aug. 2008; and “System and Method for an Electronic Lending System”, Ser. No. 61/088,239 filed 12 Aug. 2008. This application, through the '118 application, claims priority to the following provisional applications, the entirety of each is hereby incorporated herein by reference in its entirety: “BankCard Regs”, Ser. No. 61/097,381 filed 16 Sep. 2008; and “EWS Requirements”, Ser. No. 61/097,375 filed 16 Sep. 2008. Additionally, this application hereby incorporates herein by reference, in their entirety, each of the following applications: “System and Method for Business Online Account Opening”, Ser. No. 12/540,188 filed 12 Aug. 2009, now U.S. Pat. No. 8,612,339 and “System and Method for an Electronic Lending System”, Ser. No. 12/540,153 filed 12 Aug. 2009. Each of the foregoing are hereby incorporated herein by reference.

### BACKGROUND

Increasingly the public is going on-line for a variety of transactions and information. More than 30% of the population has personal computers and modems. Furthermore, over 60% of people with bank accounts have personal computers and modems. At the same time the number of people subscribing and using on-line services is greater than 40 million, and this number is growing at an exponential rate.

As the public uses computers with a greater frequency, more financial transactions are being automated and performed via computer. There is good motivation to bank on-line. On-line banking provides convenience, safety, cost savings, and potentially new types of services not readily or conveniently available via in-person banking. Such potentially new services include access to superior up-to-the minute information, on-line investment clubs, information filters, and search agents.

With the increase in the number of financial transactions performed on-line, the convenience and cost-savings of banking on-line also increases. Additionally new and more powerful methods are being developed for protecting the security of financial transactions performed on-line. The result is that convenience, cost savings and enhanced security have combined to make on-line financial services more useful and effective, thereby driving the development of newer and more integrated services. More sophisticated financial systems that offer greater integration and a high degree of user control enable on-line users to synthesize, monitor, and analyze a wide array of financial transactions and personal financial data.

Currently, methods exist for users to perform a variety of on-line financial transactions. These methods, however, fail to offer on-line account opening including qualification verifications. For example, users may bank on-line, thereby enabling performance of transactions, such as transfers from one account to another, but must already have the established account in the financial institution.

In view of the increase of electronic commerce in the market place the present subject matter discloses a unique on-line account opening method. The disclosed subject matter enables a stream-lined entry to an on-line banking presence.

A method is needed in which retail customers may establish an on-line account, be enrolled in financial offerings as a result of qualification and verification of the qualification based on a set of criteria.

In order to obviate the deficiencies of the prior art, the present disclosure presents a novel method for interfacing with a financial institution using a computer interface. In the method, a customer request is received from a customer that has reached a predetermined webpage of the financial institution using a computer network. A first content is presented to the customer, and a first input is received from the customer. A first set of information is received from the customer and presented back to the customer for review.

In the method, a second set of information is further received from the customer, the second set of information including the first set of information and any modification to the first set of information made by the customer upon their review. The terms and conditions are presented to the customer and an application is received from the customer. The second set of information is also verified.

In the method, the customer's credit score is determined using a first set of predetermined criteria and a set of account options is presented to the customer, the account options presented being based at least in part on the verification of the second set of information and the customer's credit score. A second input is received from the customer; the second input is verified and it is determined if the customer is to be enrolled for a debit card or Automatic Teller Machine (ATM) Card. The customer is processed for debit card or ATM card enrollment at a predefined level based at least on one or more predetermined factors.

Also in the method, it is determined if the customer is to be enrolled in an on-line banking program. If the customer is approved, the account numbers at the financial institution are reserved. The customer is then presented via a communication from the financial institution with information related to the customer's approved products accounts and/or enrollments.

Another method is also presented for interfacing with a financial institution using a computer interface. The method includes receiving an interface request from the customer having reached a webpage of the financial institution, presenting a group of products to the customer where the products are a function of the access path used by the customer. A choice is received from the customer along with a first set of identification information. The method further includes a review of the first set of identification information and if not verified, a request for a second set of identification information is made. If the customer identification information is verified, a predetermined client identification profile (CIP) is evaluated.

If the evaluation of the CIP is acceptable, the customer's personal information is displayed for the customer and a determination of whether a co-applicant is associated with the customer and, if so, co-applicant identification information is collected and verified. If the evaluation of the CIP is not acceptable a third set of customer identification information is further requested.

Also in the method, if the second or third set of customer identification information is required and received, determining from the information if the customer is located within an operating areas of the financial institution and, if not, obtaining a secondary residence location from the customer, a determination is also made of whether there is a co-applicant associated with the customer, if so, a set of co-applicant identification information is collected and verified. Terms and conditions of the selected products are presented to the customer and an application is received from the customer for the chosen product or products.

Furthermore, the method also contemplates the implementation and use of a real time early warning system for fraud detection and identity verification during the online account opening process. The customer may undergo this real time risk screening process using the early warning system by having business rules applied to entities associated with the customer. For example, one entity associated with the customer may be identified as the name of a “single” or “primary” applicant associated with customer. Another entity may be identified as the name of a “secondary” or “joint” applicant associated with the customer. Other entities besides those listed above are contemplated by this disclosure. Of course, the “name” may also include other identifying information such as address, phone number, tax identification number, a government-issued identification number, etc. Additionally, the early warning system and/or methodology may differentiate between a customer who is currently an online client of the financial institution and a customer who is not currently an online client of the financial institution.

In a typical prior art financial institution online interfacing process, fraud detection and identity verification of a customer opening an online account may not take place until sometime after the online account has been opened and is accessible to the customer. Obviously, this puts the financial institution in a position of unnecessarily heightened risk. Earlier fraud detection and identity verification processes are necessary to reduce this unnecessary risk to the financial institution. Otherwise a fraudster may have access to a fraudulently-obtained online account before the account is shut down.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1A is a flow chart of an embodiment of the disclosed subject matter.

FIG. 1B is a flow chart of additional subject matter discloses as complementary with the embodiment in FIG. 1A.

FIG. 2 is a flow chart of another embodiment of the disclosed subject matter.

FIG. 3 is a flow chart representing a verification process based on the evaluation outcome of a customer's CIP according to an embodiment of the disclosed subject matter.

FIG. 4 is a flow chart representing additional subject matter disclosed as complementary with the embodiment in FIG. 2.

FIG. 5 is a flow chart representing the yet additional subject matter disclosed as complementary with the embodiment in FIG. 2.

FIG. 6 is a flow chart representing further subject matter disclosed as complementary with the embodiment in FIG. 5.

FIG. 7 is a flow chart representing further subject matter disclosed as complementary with the embodiment in FIG. 5.

FIG. 8 is a representative chart of customer correspondences from the financial institution and associated triggers.

FIG. 9 is a flow chart of an embodiment of a method for interfacing with a financial institution comprising the disclosed early warning system subject matter.

FIG. 10 is a flow chart of another embodiment of a method for interfacing with a financial institution comprising the disclosed early warning system subject matter.

FIG. 11 is a table representing single applicant rules and joint applicant rules for an embodiment of an early warning system of the disclosed subject matter.

### DETAILED DESCRIPTION

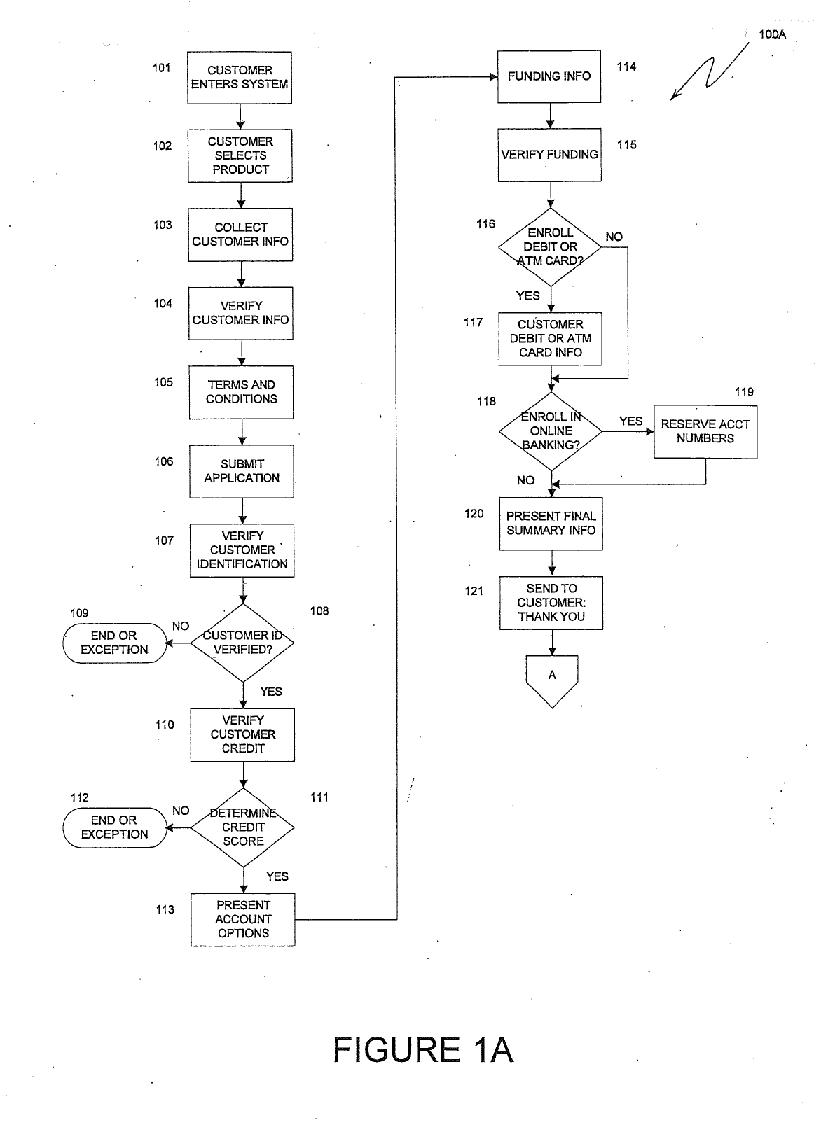

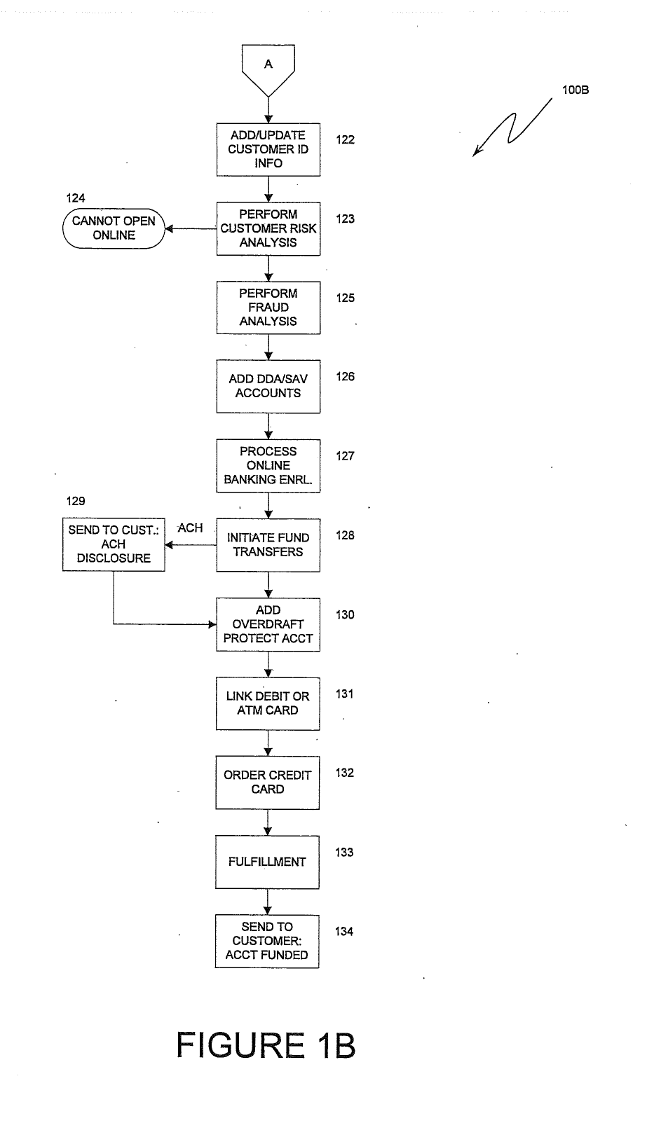

FIG. 1 illustrates a process in which a customer may open an on-line retail account via a computer network, e.g., the Internet, by accessing and exchanging information using the website of a financial institution. The customer enters the system by accessing or being directed to the institutions' website (webpage) as shown in Block 101. In either event, a request for the website is received by the financial institution's server or proxy server. The customer is presented a list of products such as a checking account, savings account, an on-line only savings account or brokerage account or any of a number of financial products offered by the institution. These financial products may also include a deposit account, which may be in the form of a certificate of deposit, individual retirement account, retirement account, a 401(k) account, tax-deferred college savings account or combination thereof. The selection of products presented to the customer may also be a function of path used by the customer to arrive at the website. For example, if the customer accessed the website via a hyperlink on another site directed to retirement, only the retirement accounts may be presented, or the entire scope of products is presented but the retirement accounts may be highlighted. In this manner, the most relevant products based on the customer's path may be brought to the customer's attention.

Following FIG. 1, the customer may then select a product from the products presented as shown in Block 102. A first set of information is requested of and received from the customer as shown in Block 103. Upon receiving the first set of information (customer's information), the information is verified. The information may include the name, his/her physical address, date of birth, SSN or part thereof, contact information such as phone numbers and email addresses, citizenship, and information regarding the characteristics of the identification (e.g. type, ID Number, State of issuance, issue date and expiration date), user name, password or other identifying indicia/code that enables the identification of the customer or links the customer to the customer's established account(s).

The first set of information is verified as shown in Block 104. This verification may include presenting back to the customer for review the first set of information and receiving a second set of information which includes any corrections to the first set of information the customer has made, the second set of information may also include information regarding a co-applicant. The website may allow and request the customer to annotate, modify or otherwise change incorrect or incomplete information upon its presentation to the customer. The customer is also provided with a set of terms and conditions which may govern the use of the website, on-line banking, application process, liabilities, etc., as shown in Block 105. The terms and conditions may also include a customer check-off which may be required to continue and ensure they have been at least noticed, if not reviewed by the customer. The terms and conditions may include an electronic disclosure, a retail bank services agreement, a state pricing guide, a corporate privacy notice, and a tax identification number certification as well as others common to the industry. An application for a product may be submitted by and received from the customer as shown in Block 106. The customer identification is then verified in Block 107.

Still in FIG. 1, if the customer identification is not verified in decision Block 108, the process ends or an exception may be granted as shown in Block 109 of FIG. 1. If the customer ID is verified, the customer's credit score which is representative of the customer's credit worthiness is determined and verified as shown in Block 110. The credit score is determined using a second set of predetermined criteria. The criteria includes whether the customer is a new or existing client of the financial institution, has customer been identified as fraudster or abuser by the financial institution; has the customer been identified as a fraudster by a third party or another financial institution and does the customer identity verification score exceed a predetermined threshold. Of course additional criteria reflective of the customer's credit worthiness may also be applied.

Still referring to FIG. 1, a decision on the customer's credit is made as shown in Block 111. If the customer's credit is not approved, an exception may be made or the application process may be terminated as shown in Block 112. The process of ending the application or granting an exception is discussed later. If the customer's credit is accepted, customer account options are presented as shown in Block 113.

The account options presented may be based at least in part on the verification the second set of information and the information regarding the customer's credit score. The account options presented may also be a function of a set of risk evaluation rules. These rules may include decisions on a social security number evaluation, an identity theft evaluation, a retail indicator evaluation, a previous inquires evaluation, a closure summary evaluation and a closure details evaluation. The decisions may be go/no-go or may be qualitative in nature. For example, if the social security number does not match the name, a no-go decision may be rendered, whereas the previous inquires evaluation may result in a go/no-go decision or a qualified approval dependent upon another condition.

Upon the selection of the account options, funding options may then be presented to the customer as shown in Block 114. The funding options presented may advantageously be based on the account options (products) selected by the customer.

The funding options are the methods in which the account options are to be created or funded. These options may include sending of a check, making a deposit at the financial institution or an affiliate, transfer of funds from another external financial institution or a transfer from a pre-existing account at the financial institution. In addition, other information may be requested from the customer for compliance purposes. The funding source may then be verified as shown in Block 115 by presenting back to the customer all accounts, funding methods, source of initial funds and the amount originally entered. The customer may modify any of the funding information before finalizing and submitting the funding. The customer may then be qualified for a debit card (check card) or ATM card.

In decision Block 116 it is determined whether the customer is to be enrolled for a debit card or ATM card. The decision to be enrolled in a debit card may be determined as a function of the information previously supplied by the customer. If the customer is to be enrolled for a debit card, information regarding the enrollment is collected and a level of enrollment is determined as shown in Block 117. The level of enrollment may be based on at least one or more predetermined factors based upon risk factors or financial factors, for example a low credit score would lead to a lower level while substantial assets may advocate for a higher level of enrollment. In addition, the status of other accounts may also be used to determine the level of enrollment for the debit card or ATM card. The customer may be advantageously allowed to select a personal identification number (PIN) for the debit card or the ATM card. The PIN may also be automatically selected by the institution. It is next determined if the customer is to be enrolled in on-line banking as shown in Block 118. The on-line banking program if selected reserves account numbers as shown in Block 119.

The customer is presented with a final presentation including customer information related to the customer's selected products, accounts and or enrollments reflective of the status of their on-line banking opening as shown in Block 120. The final presentation may present a summary of the product offerings selected by the customer. The name on the debit card and ATM cards, authorization level may also be displayed for all debit cards enrolled. Accounts having overdraft protection selected, may also be identified along the overdraft account information. Bank Card offers that were accepted may be displayed as well as other third party offers accepted by the customer. The nearest branch location and other information a new client would find useful may be displayed as well. Contact information including phone number, addresses, email addresses and web pages may be presented to the customer during final presentation.

Additional products and offers may be communicated to the customer in the final summary, these products and offers may be only tangentially related or provided by third parties, these advertisements may also be presented based on the information collected during the on-line process and may be selected by the financial institution. Selection by the financial institution prevents the unwanted disclosure of private information but still allows the advertising to be marketed based on financial status. The customer may also be given the opportunity to order checks and other products related to the opening of the account. For this additional product offering, the customer may be connected to another site. Upon fulfillment of the terms and conditions of enrollment and funding, the on-line banking opening may be complete as evidenced by a thank you or other correspondence sent to the customer as shown in Block 121. Telephone assistance may also be available while in the process of on-line banking enrollment, to further aid the process. Telephone support may also be accessed after the opening process ends.

A flow chart 100B is shown in FIG. 1B. The flow chart shows additional steps that may be performed by the financial institution in conjunction with the steps shown in FIG. 1A. These steps are typically considered back room operations that are transparent to the customer. From the information gained during the application process discussed above, the customer's identification information may be augmented or updated as shown in Block 122. A risk analysis is performed on the customer to determine if the customer's activities present an unacceptable or acceptable risk as shown in Block 123. If the risk analysis yields an unfavorable result indicating the customer is high risk, the account may not be opened on-line as shown in Block 124. In such a case the customer may be required to appear in person to facilitate the account opening. In addition, a fraud analysis is performed on the customer in Block 125. This analysis may include determining if the customer is listed as a fraudster on an internal or external database. The fraud analysis may also include evaluation of the customer's provided information, such as whether the SSN is associated with a person who is deceased, or if the SSN was issued prior to the customer's reported birth date, other checks such as determining if the mailing address is associated with a prison or other notorious entity would also be advantageous. If the fraud analysis presents red flags or warnings the account may be prevented from being opened on-line as discussed above.

New accounts for the customer may be opened based on the customer's approved products, accounts, and/or enrollments at the financial institution as shown in Block 126. In the particular example the new account, added in Block 126, includes a demand deposit account (DDA) and a savings account (SAV). The financial institution also processes the on-line banking enrollment, if approved, as shown in Block 127 and initiates a fund transfer to the new customer account as shown in Block 128. Along with the funds transfer, the customer is sent an automatic clearing house ACH or electronic funds transfer EFT disclosure as required in Block 129. In Block 130, the new account or accounts are linked to an overdraft account such as a savings account, credit card, or line of credit. The debit card or ATM card is also linked to the new account or accounts as shown in Block 131. The credit card offers that are accepted by the customer are ordered from a card management system which may be internal or part of a third party financial institution as shown in Block 132 and the fulfillment information is processed in Block 133. Upon funding of the new customer account, a communication, such as an email, SMS, text message, tweet, posting, letter, phone call or other type is sent to the customer to indicate the funding as shown in Block 134.

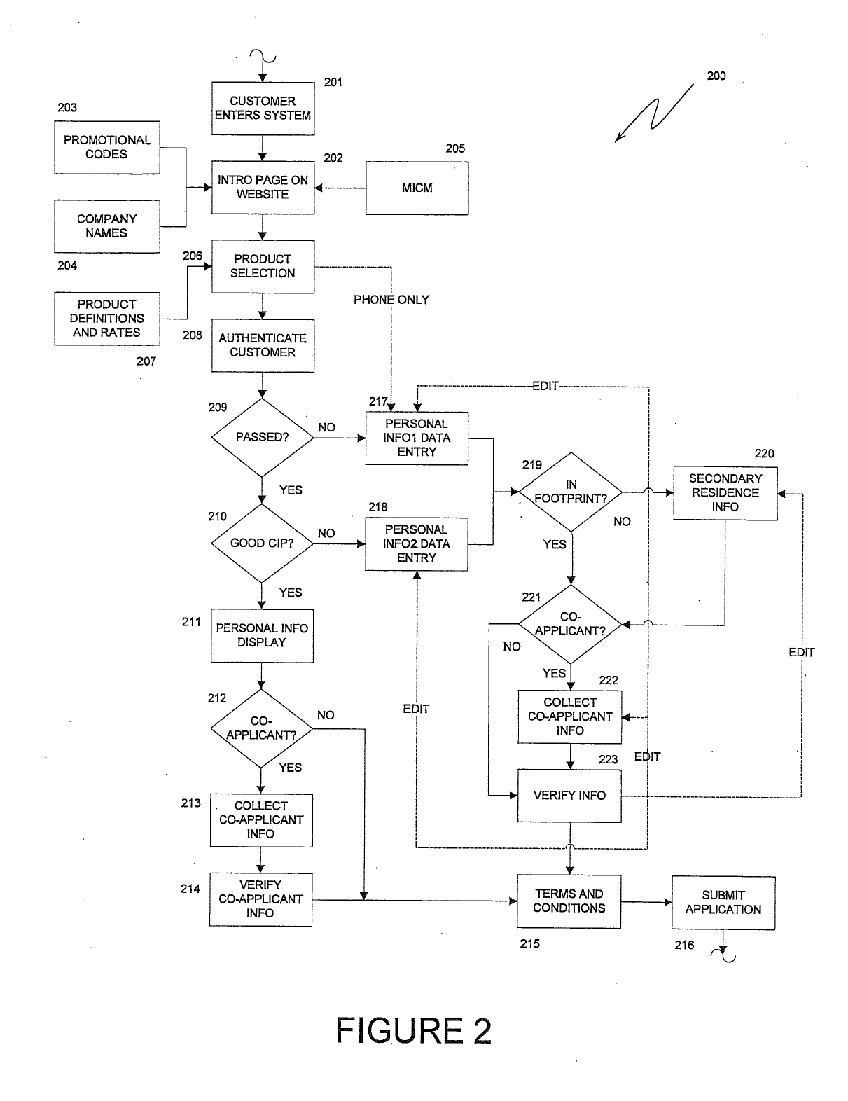

FIG. 2 shows a method 200 of obtaining an on-line application. The customer enters the system in Block 201, where promotional codes and Company names associated with the financial institution in Blocks 203 and 204 respectively may be advantageously included on the introduction page on the website Block 202. Other favorable indicia for, example, Member of the Institute of Credit Management (MICM) 205 and/or Member of FDIC also may be included on the introduction page. The promotional codes and company names as noted previously and even the additional indicia may be a function of the path by which the customer arrived at the financial institution's website as well as the products offered.

The products offered on the website may also include more or less detailed descriptions as well as the cost, rates and duration periods as shown in Block 207. This information may be on the introduction page or accessible from a selectable pop up window or hyperlink. The customer's product selection is made and received by the financial institution or server as shown in Block 206.

In FIG. 2, following receipt of the customer's product selection the customer is authenticated as shown in Block 208, the authentication may advantageously include the collection of customer identification information, as discussed previously. If the customer successfully passes the authentication as shown in decision Block 209, a predetermined client identification profile (CIP) for the customer is evaluated as shown in Block 210. The predetermined client identification profile is determined internally from internal and external information such as information from LexisNexis™ products. If the evaluation is acceptable the customer's personal information is displayed on the customer's viewing device as shown in Block 211 and attention is then turned to that of a co-applicant if one is determined, as shown in decision Block 212. Information is collected on the co-applicant in Block 213 and that information is verified as shown in Block 214. Absent a co-applicant the terms and conditions associated with the products, website and on-line accounts are presented to the customer as shown in Block 215 and the customer submits the application for the selected products as shown in Block 216. Generally, the co-applicant is subjected to similar checks as the customer.

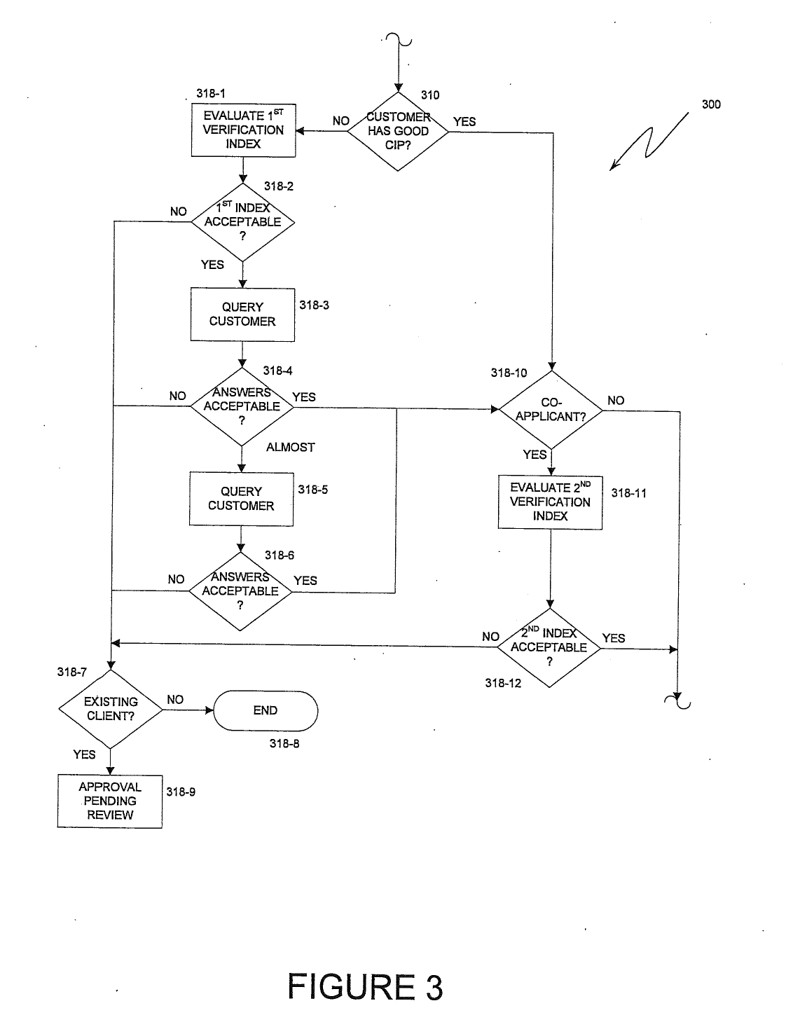

If, however, the customer does not pass the customer authentication in decision Block 209, then an additional set of information (INFO1) is requested and entered by the customer. Additionally, customers using a telephone to create the on-line account may also be requested to provide this additional set of information as the webpage authentication process is bypassed. Additional information (INFO2) is also requested if the CIP is found not acceptable in decision Block 210, further processing is described with respect to the CIP outcome in FIG. 3 later. The additional information requested may be identical in both cases. Upon receipt of the additional information, INFO1 or INFO2, a determination is made on whether the customer is located within an operating area of the financial institution or within the financial institution's geographic footprint as shown in Block 219. If not, secondary residence information is requested and obtained from the customer, in either case a determination of whether there is a co-applicant is made in decision Block 221. If there is a co-applicant, their information is collected and verified in Blocks 222 and 223 respectively, otherwise the terms and conditions are presented in Block 215 and an application is submitted as shown in Block 216, as discussed previously. The terms and conditions may include an electronic disclosure, a retail bank services agreement, a state pricing guide, a corporate privacy notice, a personal privacy notice and a tax identification number certification as well as others common to the industry. FIG. 2 also shows that the additional information, co-applicant information and secondary residence information may be edited by the customer any time prior to submission of the application.

Turning to FIG. 3, an alternative or complementary method 300 to method 200 in FIG. 2 is shown. The method begins following the determination of whether the customer has a good CIP as shown in decision Block 310. If the customer has a good CIP, attention is turned to whether there is a co-applicant. If there is no co-applicant indicated in decision Block 318-10, then an application may be submitted. The process for a co-applicant will be discussed shortly. A determination that the customer does not have a good CIP in Block 310 results in an evaluation of a first verification index as shown in Block 318-1. If the first index is found acceptable in decision Block 318-2, then the customer is queried with one or a series of questions as shown in Block 318-3. The customer's answers are then verified and a determination of whether they are, or almost are acceptable is made in decision Block 318-4. If they are acceptable a determination of whether there is a co-applicant is undertaken in Block 318-10. If the answers are not acceptable then a determination on whether the customer is an existing client is undertaken as shown in Block 318-7. A third outcome may stem from decision Block 318-4, the answers may almost be acceptable. In the case of almost acceptable answers, the customer is queried a second time as shown in Block 318-5 and a yes or no determination of whether these second set of answers are acceptable. If they are not, a determination of whether the customer is an existing client is undertaken in Block 318-7. If the second set of answers are acceptable, a determination of whether there is a co-applicant is undertaken in Block 318-4. Continuing with Block 318-4, if there is no co-applicant then an application may be submitted following a presentation of the terms and condition. If there is a co-applicant in Block 318-4, then a second verification index is evaluated as shown in Block 318-11. If the second verification index is found acceptable in decision Block 318-12 then an application may be submitted, otherwise a determination of whether the customer is an existing client is made in decision Block 318-7. A negative decision reached in Block 318-7 indicating the customer is not an existing client may lead to a termination of the on-line process as shown in Block 318-8, whereas a positive decision from Block 318-7 may lead to a pending status, where approval is subject to a review process as shown in Block 318-9. This additional review process may advantageously include review of the past and current relationship between the financial institution and the customer, as well as other considerations related to the customer's client status.

For example, if the name, address, phone number and SSN match, a score reflecting a high matching comparison is given, whereas when one or more of these do not match, a score reflecting a lower matching comparison is applied. The customer is queried regarding answers related to his/her identity for verification. Questions in the query may include for example information typically known only to the individual, such as mother's maiden name, previous address, banking accounts etc.

Each verification index represents evaluations using a particular set or area of information. The sets or areas of information may or may not be mutually exclusive. One verification index may be based on information which includes searches drawn from public records and directories. Another verification index may be based on the applicant information, for example, name, address, Social Security Number (SSN) and contact information. Yet another verification index may be based on past relationships between the customer and financial institutions. These verification indices may be performed internal by the financial institution or by a third party. The verification indexes may be compared to a predetermined threshold to determine if it is acceptable.

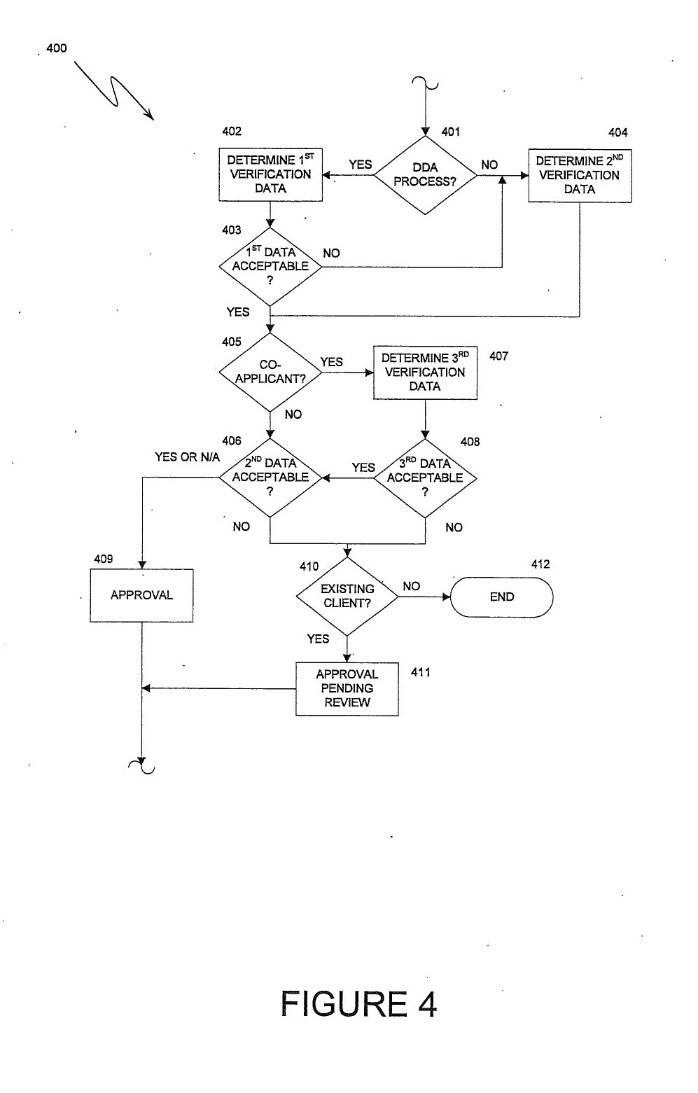

FIG. 4 illustrates a method 400 tied to whether a demand deposit account (DDA) is selected by the customer or not. As shown in FIG. 4, a determination that a DDA has been selected from Block 401 may lead to determining a first set of verification data as shown in Block 402. The first set of verification data may include information derived from an third party or held internally by the institution. This first set of verification data may be obtained internally or from a third party such as Equifax™ or ChexSystems™ for example. The first set of verification data is evaluated in Block 403. If the first set of verification data is not acceptable or a DDA was not selected in Block 401, a second set of verification data is determined from another internal database or another of the third party providers. If the second set of verification data is not acceptable as shown further down FIG. 4 in Block 406 a determination is made whether the customer is an existing client in Block 410. If the first verification data is found acceptable in decision Block 403, then a determination is made regarding a co-applicant in decision Block 405. Where there is no co-applicant and either the first or second set of verification data are acceptable from Blocks 403 or 406 respectively, the customer is approved for a DDA as shown in Block 409.

If there is a co-applicant and the first or second verification data is acceptable, a determination of a third set of verification data is made as shown in Block 407, if the third set of verification data is acceptable in Block 408, the customer again is approved for a DDA as shown in Block 409, else a determination on whether the customer is an existing client is made in Block 410. If upon reaching a negative determination regarding whether the customer is an existing client in Block 410, the process is terminated as shown in Block 412. If however, from decision Block 410, a positive determination is reached, the customer's approval is placed in a pending status and a further review of the customer is undertaken prior to a final approval decision as shown in Block 411. Customers pending may be manually reviewed by the financial institution, however information and product presentation may continue until the review is completed.

The evaluation of the second or third verification data includes applying a predetermined set of business rules, these rules may dictate a go/no-go decision based on the results of a social security number evaluation, a tax identification number evaluation, an identity theft evaluation, a retail indicator evaluation, a previous inquiries evaluation, a closure summary evaluation, and a closure details evaluation or a combination of these. These rules may relate to past customer activities.

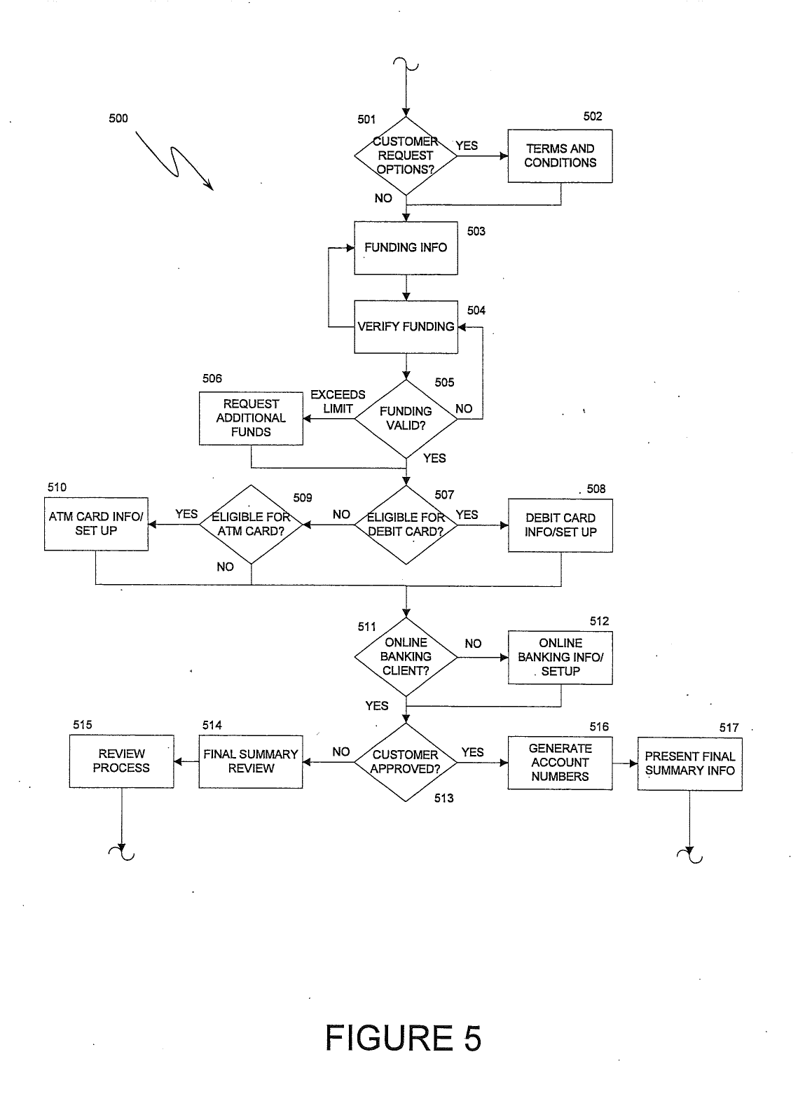

Turning to FIG. 5, a determination is made in Block 501 on whether the customer requested an option package, if so the customer is presented with the terms and conditions associated with the option package as shown in Block 509. As shown in Block 503 information regarding amount and from what source the new account will be funded is obtained from the customer. The funding information is then verified in Block 504. If the funding information including amount is valid, as determined in Block 505, the customer's eligibility for a debit card is determined, if however the funding source is not valid, the customer is asked for a different source, or if the amount is insufficient to open the account the customer may be asked for addition funds as shown in Block 506.

After the account is funded, the eligibility of a debit card is determined in decision Block 507. If the customer is eligible for a debit card, the debit card information is determined and established as shown in Block 508. If the customer is not eligible for a debit card, a determination is made in Block 509 of whether the customer is eligible for an ATM card, if so the ATM card information is determined and the service is established. It is then determined whether the customer is an on-line banking client or not, as shown in Block 511, if not, on-line banking information is obtained and the on-line banking service is established for the customer as shown in Block 512. If the customer is approved for either the debit card or the ATM card as shown in Block 513 the account numbers for the approved cards are generated at the financial institution as shown in Block 516, additionally, the customer may be prompted to select their PIN number at this point or earlier such that the account numbers and PIN may be matched up. A final summary information is also presented to the customer. If the customer is not approved for a card a final summary review is presented to the customer as shown in Block 514 and the customer is placed in a review process as shown in Block 515.

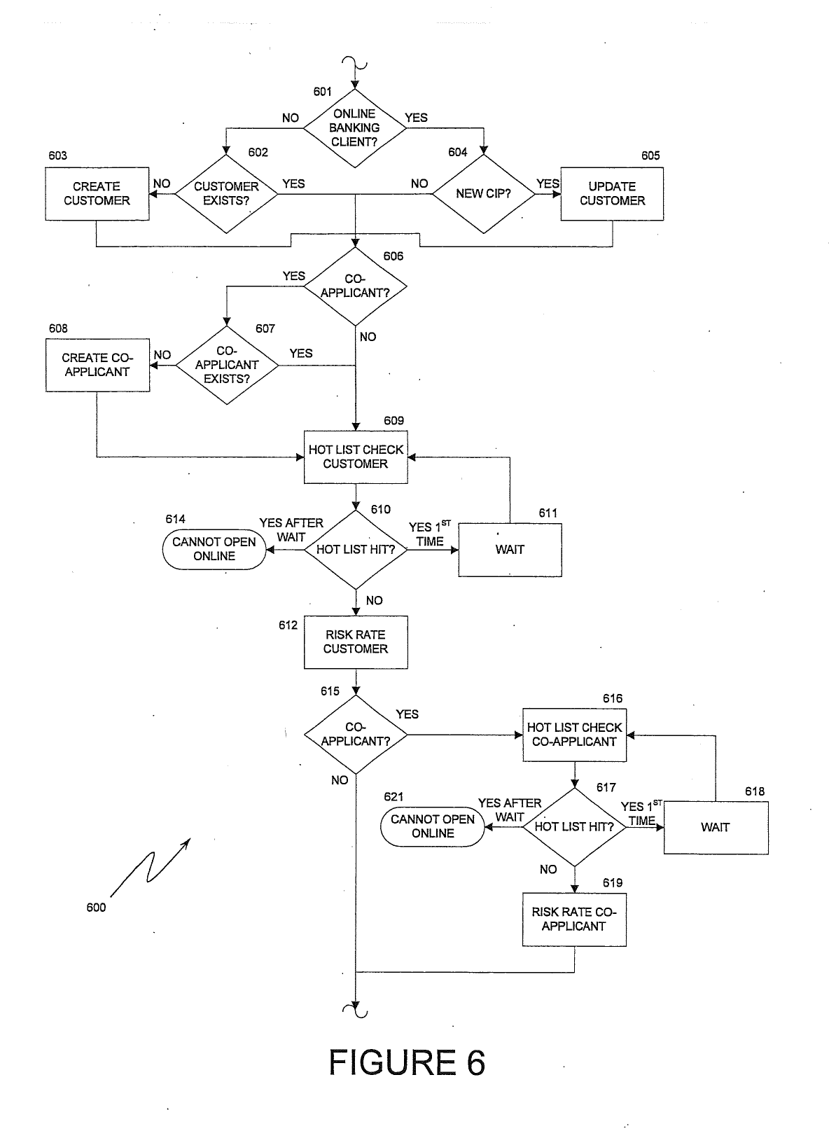

In FIG. 6, method 600 first determines whether the customer is an on-line banking client of the financial institution as shown in decision Block 601. If the customer is an on-line banking client, a determination is made as to whether a new client identification profile (CIP) needs to be created for the customer as shown in Block 604. If a new CIP is needed, a set of customer information used to determine the client identification profile is updated as shown in Block 605. After updating the information for the customer, a determination whether there is a co-applicant is made in Block 606. Going back to decision Block 601, if the customer is not an on-line banking client of the financial institution, a determination is made whether a set of customer information exists in Block 602 and if not a set of information is created as shown in Block 603, else the process returns to the determination of whether there is a co-applicant in Block 606. If there is a co-applicant, a determination of whether information regarding the co-applicant exists is made in Block 607 and, if not, a set of co-applicant information is created as shown in Block 608.

A hot list check is performed on the customer as shown in Block 609. This hot list check may be a regulatory requirement stemming from, for example, the Patriot Act and/or Office of Foreign Assets Control (OFAC). This check may be performed regardless of the outcomes of the decision Blocks 601, 602, 604, 606 and 607. If there is not a hit on the hot list check on the customer in Block 610, the process continues to Block 612, otherwise a wait is initiated for a predetermined amount of time as shown in Block 611 and the hot list check is performed again. If there is no hit during the subsequent performance, the process continues onto Block 612, otherwise, the customer is not permitted to open the account on-line as illustrated in Block 614. The predetermined wait may be a matter of hours or days and may depend on the update frequency of the list. Having no hits on the hot list, the customer's activities are then rated for risk in Block 612. A determination is then made regarding a co-applicant as shown in Block 615. If there is a co-applicant, an identical hot list check is performed on the co-applicant in Block 616, as was for the customer. If there is not a hit on the hot list check of the co-applicant in Block 617, the process continues to Block 619, otherwise a wait is initiated for a predetermined amount of time as shown in Block 618 and the hot list check is performed again. If there is no hit during the subsequent performance, the process continues onto Block 619, otherwise the co-applicant is not permitted to open the account on-line as illustrated in Block 621. Having no hits on the hot list, the co-applicant's activities are now rated for risk in Block 619.

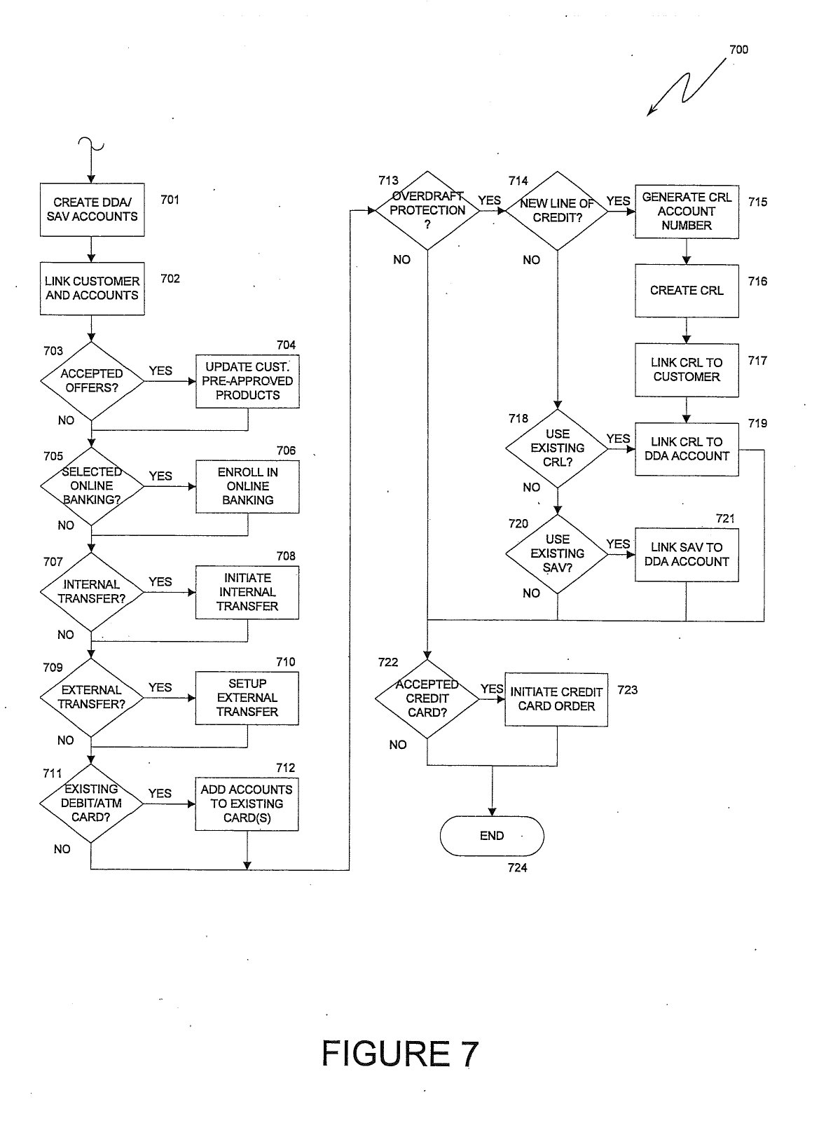

Turning now to FIG. 7, a method 700 is shown establishing the accounts and services requested by and approved for the customer. In Block 701 the requested and approved accounts are created for the customer, such as a DDA and/or a SAV. The customer is then linked preferably to all the account created for the customer as shown in Block 702. A determination is then made whether the customer has accepted any additional offers presented by the financial institution or third party vendor as shown in Block 703 and if so, updating a list of preapproved products for the customer as shown in Block 704. A determination is then made whether the customer has selected to enrolled in an on-line banking program as shown in Block 705, if so the customer is enrolled in the on-line banking program as shown in Block 706. A determination is made whether the customer's funding is via an internal transfer from a preexisting account at the financial institution, as shown in Block 707. If so, the internal transfer is initiated at the financial institute as shown in Block 708. If the transfer is external as determined in Block 709, then the setup required for such an external transfer is initiated as shown in Block 710. As shown in Block 711, a determination of whether the customer has existing debit cards or ATM cards with the financial institution. If the customer does have these existing cards, they may be linked to the new accounts opened by the customer as shown in Block 712. A further determination is made regarding overdraft protection of the new accounts as shown in Block 713, if no overdraft protection is selected the process continues to Block 722, otherwise the source of the overdraft protection may be established and/or linked to the new account.

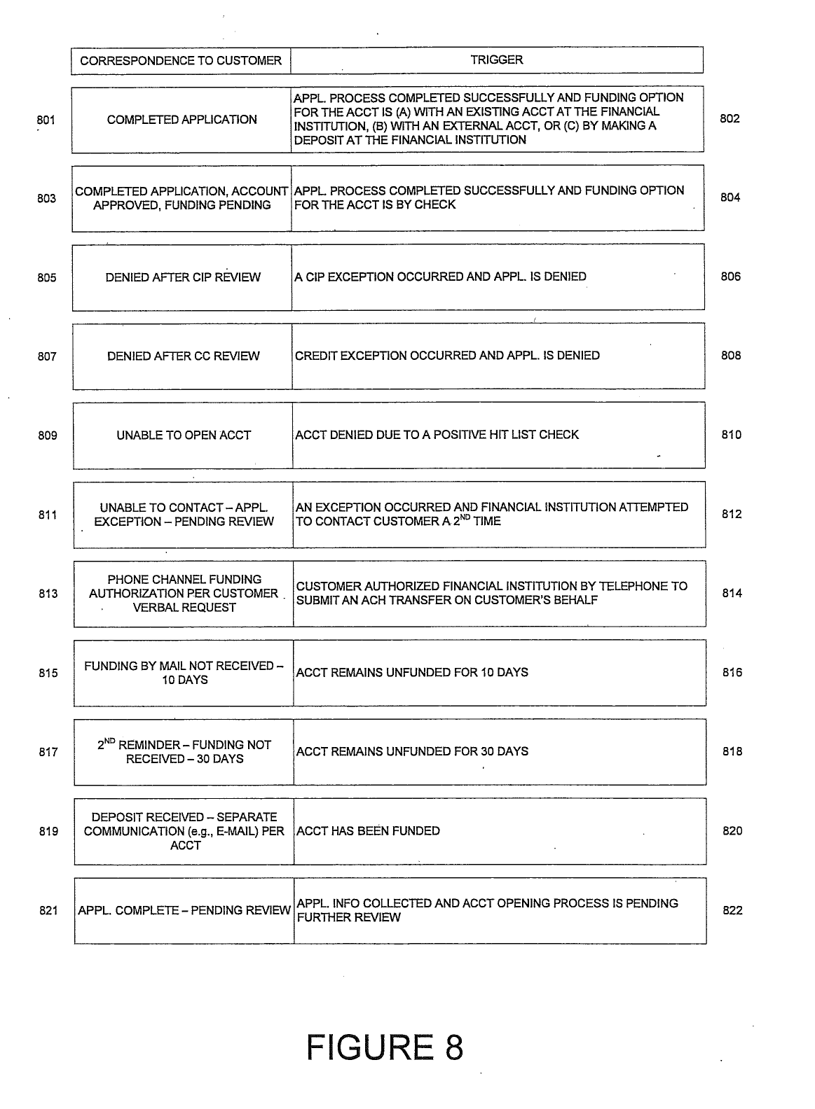

If the customer selects a new line of credit to provide overdraft protection in decision Block 714, a new credit line (CLR) account number is generated in Block 715, a new credit line account is created with the generated number in Block 716 and the credit line account is linked to the customer in Block 717, and the customer's credit line account used for overdraft protection is linked to the customer's DDA as shown in 719. The customer may have chosen not to open a new line of credit to provide overdraft protection and instead use an existing credit line account as shown in decision Block 718, in which case the customer's existing credit line account is linked to the DDA as shown in Block 719. The customer may also have decided to provide overdraft protection using an existing or new savings account in decision Block 720, in which case the savings account is then linked to the DDA account as shown in Block 721. The customer in the process of opening a new account may have accepted a credit card, upon such a determination in Block 722, a credit card order internally or to the card management service is initiated, as shown in Block 723. As noted previously, many of these steps are back room operations transparent to the customer. However, the progress of these steps may be reported to the customer as an indication of progress in the account opening. Direct correspondences with the customer informing them of the status of their accounts may also be advantageous. Exemplary customer correspondences and triggers are shown in FIG. 8.

FIG. 8 lists correspondences (messages) to the customer as well and the event or occurrence that triggers the message being sent, the list is exemplary only. A message 801 “COMPLETED APPLICATION” is sent when the application process has been completed successfully and the funding option for the new account is with an existing account located at the financial institution, with another financial institution (external account) or by making a deposit at the financial institution as shown in Block 802. The message 803 “COMPLETED APPLICATION, ACCOUNT APPROVED, FUNDING PENDING” may be sent upon when the application process has been completed successfully and the funding option for the new account is by check as shown in Block 804. The message 805 “DENIED AFTER CIP REVIEW” may be sent when a CIP exception occurred and after review the application is denied as shown in Block 806. The message 807 “DENIED AFTER CC REVIEW” may be sent when a credit exception occurred and after review the application is denied as shown in Block 808. The message 809 “UNABLE TO OPEN ACCT” may be sent when the account opening is denied due to a positive hit list check as shown in Block 810. The message 811 “UNABLE TO CONTACT-APPL. EXCEPTION-PENDING REVIEW” may be sent when an exception occurred and the financial institution attempted unsuccessfully to contact the customer a second time as shown in block 812. The message “PHONE CHANNEL FUNDING AUTHORIZATION PER CUSTOMER VERBAL REQUEST” may be sent when the customer authorized the financial institution by telephone to submit an ACH or EFT transfer on customer's behalf as shown in Block 814. The message 815 “FUNDING BY MAIL NOT RECEIVED-10 DAYS” may be sent when the account remains unfunded for 10 days as shown in Block 816. The message 817 “SECOND REMINDER-FUNDING NOT RECEIVED-30 DAYS” may be sent appropriately after the account remains unfunded for 30 days as shown in Block 818. The message 819 “DEPOSIT RECEIVED-SEPARATE COMMUNICATION (e.g. E-MAIL) PER ACCT” may be sent when the account has been funded as shown in Block 820. The message 821 “APPL. COMPLETE-PENDING REVIEW” may be sent when the application information collected and account opening process is pending further review as shown in Block 822. These messages as well as others may be modified and tailored depending on the correspondence type.

Embodiments of the disclosed subject matter may utilize drop down menus to show the options available to the customer and simplify their selection. Auto fill options may also be utilized for the convenience of the customer. The website format may also be selectable for use in mobile equipment such as Blackberries and PDA equipment, where screen space and functionality may be more limited than on a personal computer. Communications between the customer and the financial institution during the opening of an account may advantageously be encrypted.

The methods of retail on-line account openings may be implemented using various software, hardware and protocols. Additionally, information collected via the on-line opening process may be stored in a database for access at a future time. Time outs may also be utilized in the method to require selections and information to be input by the customer be contemporaneous with the requests.

The on-line opening utilizes advantageously utilizes real time evaluation of the risks due to fraud and identity by using information previously collected by the institution as well as information obtained from third parties. The decrease in processing times from days to minutes increases the convenience of account opening significantly.

As discussed above, in a typical prior art financial institution online interfacing process, fraud detection and identity verification of a customer opening an online account may not take place until after business hours the day the online account is opened or, perhaps, the next business day after an online account has been set up at the financial institution. Therefore, under certain circumstances, the fraud detection and identity verification of the customer may not take place until four days after an online account is opened. For example if the online account is opened on the Friday before a three-day weekend, the fraud detection and identity verification processes may not take place until the following Tuesday. Obviously, this puts the financial institution in a position of unnecessarily heightened risk. Earlier fraud detection and identity verification processes are necessary to reduce this unnecessary risk to the financial institution. Otherwise a fraudster may have access to a fraudulently-obtained online account for four days before the account is shut down.

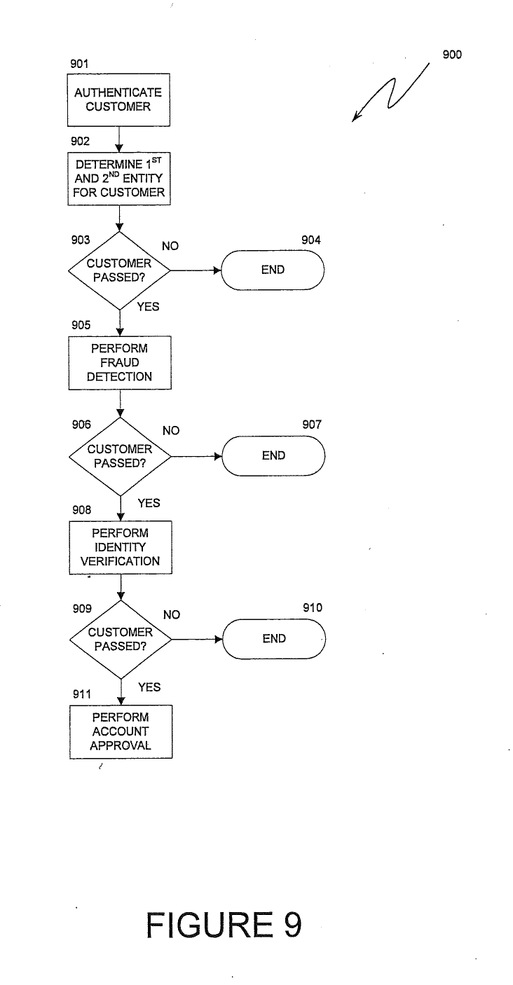

FIG. 9 is a flow chart of an embodiment of a method for interfacing with a financial institution comprising the disclosed early warning system subject matter. Typically, a customer may connect via a computer network (e.g., the internet) to a website for a financial institution and request to interface with the financial institution through the website. The request may be, for example, to open an online business account, as described herein, with the financial institution. The financial institution may receive identification information for the customer and, at Block 901, the financial institution may attempt to authenticate the customer by, among other things, referring to a predetermined client identification profile (“CIP”) The CIP may contain information (public or otherwise) about the customer that was obtained either by the financial institution or for the financial institution from other sources. At Block 902 the financial institution may determine entities associated with the customer. For example, one entity associated with the customer may be identified by the name (as described above) of a “single” or “primary” applicant identified by the customer. Another entity may be identified by the name (as described above) of a “joint” or “secondary” applicant identified by the customer. Other entities besides those listed above are contemplated by this disclosure. Of course, the “name” may also include other identifying information such as address, phone number, tax identification number, a government-issued identification number, etc.

At decision Block 903 a determination may be made as to whether the customer has passed the authentication process. The determination of passing the authentication process may be based on individual checks on one or more of the entities associated with the customer. If the customer did not pass the authentication process, the process may end at Block 904. If the customer did pass the authentication process at decision Block 903, the process may continue to Block 905.

At Block 905 a fraud detection process may be performed on the customer. Details of the fraud detection process appear below. If the customer does not pass the fraud detection process at decision Block 906, the interfacing process may end at Block 907. If the customer passes the fraud detection process at decision Block 906, the customer may undergo an identity verification process as shown at Block 908. Details of the identity verification process appear below. If the customer does not pass the identity verification process at decision Block 909, the interfacing process may end at Block 910. If the customer passes the identity verification process at decision Block 909, the customer may be passed on for an account approval process at Block 911 and from there the customer may continue with the interfacing procedure as described herein.

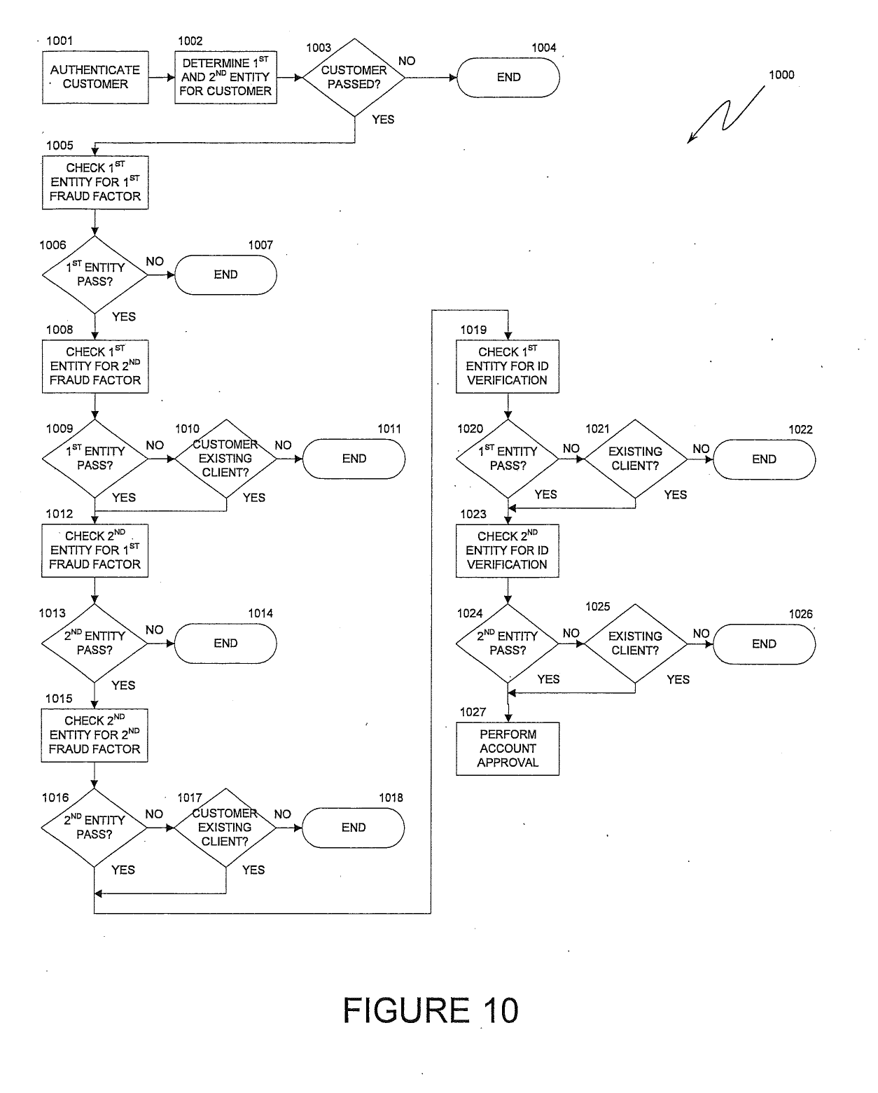

FIG. 10 is a flow chart of another embodiment of a method for interfacing with a financial institution comprising the disclosed early warning system subject matter. Typically, as discussed above, a customer may connect via a computer network (e.g., the internet) to a website for a financial institution and request to interface with the financial institution through the website. The request may be, for example, to open an online retail account, as described herein, with the financial institution. The financial institution may receive identification information for the customer and, at Block 1001, the financial institution may attempt to authenticate the customer (as discussed above) by, among other things, referring to a predetermined client identification profile (“CIP”) The CIP may contain information (public or otherwise) about the customer that was obtained either by the financial institution or for the financial institution from other sources. At Block 1002 the financial institution may determine entities associated with the customer as discussed above. At decision Block 1003 a determination may be made as to whether the customer has passed the authentication process, as discussed above. The determination of passing the authentication process may be based on individual checks on one or more of the entities associated with the customer. If the customer did not pass the authentication process, the process may end at Block 1004.

At Block 1005 an evaluation may be made for a first entity (which may preferable be a single applicant associated with the customer as discussed above) for a first fraud factor. If the first entity does not pass the first fraud factor evaluation at decision Block 1006, the process may end at Block 1007; otherwise an evaluation may be made for the first entity for a second fraud factor at Block 1008. The first fraud factor (sometimes referred to herein as an “LRM Hot File” or “Hot File”) may preferably be a list of known fraudsters and/or abusers at the financial institution and may include former clients of the financial institution who have been “exited” from the financial institution, e.g., those who had an account closed by the financial institution due to various activity of the former client. The second fraud factor (sometimes referred to herein as a “Shared Fraud Database” or “Shared Fraud”) may preferably be a list containing information from the financial institution and/or other financial institutions about known fraudsters and/or abusers and/or other clients (former or otherwise) who for some reason have been exited from a financial institution.

Returning attention back to FIG. 10, at decision Block 1009 a determination may be made as to whether the first entity passed the second fraud factor evaluation. If the first entity does not pass the second fraud factor evaluation at decision Block 1009, at decision Block 1010 if the customer is not an existing client at the financial institution then the process may end at Block 1011. Otherwise, if the first entity passes the second fraud factor evaluation at decision Block 1009 or if the customer is an existing client at decision Block 1010, an evaluation may be made for a second entity (which may preferable be a joint applicant associated with the customer as discussed above) for the first fraud factor at Block 1012.

If the second entity does not pass the first fraud factor evaluation at decision Block 1013, the process may end at Block 1014; otherwise an evaluation may be made for the second entity for the second fraud factor at Block 1015. At decision Block 1016 a determination may be made as to whether the second entity passed the second fraud factor evaluation. If the second entity does not pass the second fraud factor evaluation at decision Block 1016, at decision Block 1017 if the customer is not an existing client at the financial institution then the process may end at Block 1018. Otherwise, if the second entity passes the second fraud factor evaluation at decision Block 1016 or if the customer is an existing client at decision Block 1017, the process may continue to Block 1019.

At Block 1019 the first entity may be evaluated for identity verification. The identity verification may include a validation of the first entity's name and address given to the financial institution during the online interfacing procedure. The identity verification may also include validation of other information given to the financial institution by the customer during the online interfacing procedure. In a preferred embodiment, the customer and/or an entity associated with the customer may be given a “score” for the identity verification evaluation and that score may be compared with a predetermined threshold value. The threshold value may be the same for all entities or one or more of the threshold values may be different than the threshold values of the other entities. In a preferred embodiment, an entity's identity verification evaluation score which exceeds the appropriate threshold may indicate failure of the identity verification evaluation. If the first entity does not pass the identity verification evaluation at decision Block 1020, at decision Block 1021 if the customer is not an existing client at the financial institution then the process may end at Block 1022. Otherwise, if the first entity passes the identity verification evaluation at decision Block 1020 or if the customer is an existing client at decision Block 1021, the second entity may be evaluated for identity verification at Block 1023. If the second entity does not pass the identity verification evaluation at decision Block 1024, at decision Block 1025 if the customer is not an existing client at the financial institution then the process may end at Block 1026. Otherwise, if the second entity passes the identity verification evaluation at decision Block 1024 or if the customer is an existing client at decision Block 1025, the process may continue to performing an account approval evaluation at Block 1027 and from there may follow the online account opening procedure described above.

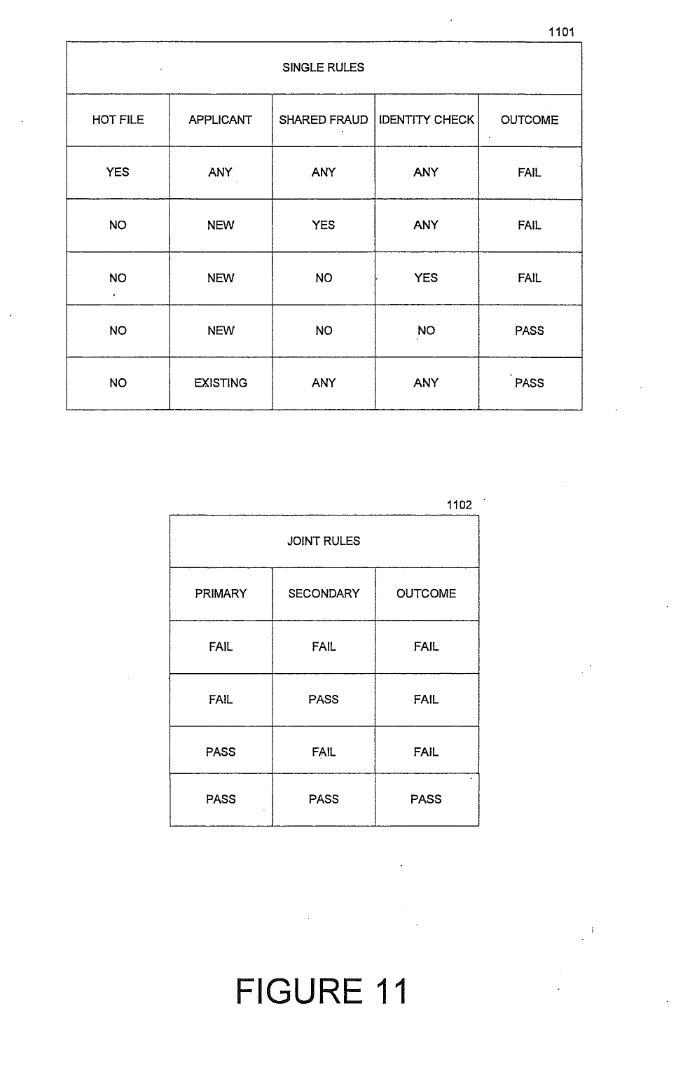

FIG. 11 is a table representing single applicant rules and joint applicant rules for an embodiment of an early warning system of the disclosed subject matter. FIG. 11 is a table 1101 representing single rules and a table 1102 representing joint rules for an embodiment of an early warning system/methodology of the disclosed subject matter. With reference to table 1101, the first column lists results for the Hot File evaluation, the second column lists whether the customer (or applicant) is an existing client of the financial institution, the third column lists results for the Shared Fraud evaluation, the fourth column lists results for the identity verification evaluation, and the fifth column lists the overall outcome of the evaluation given the results in the first four columns. As an example for following the logic in table 1101, assume that the single applicant associated with the customer is referred to as the first entity. Then, for the first of the five rows of results that appears in table 1101, if the first entity fails the Hot File evaluation (i.e., the first entity appears on the Hot File) the overall outcome is that the customer will “fail”, i.e., the customer will not be allowed to continue with the online interfacing procedure. In this case, this result will occur regardless of any other evaluations that may be performed or the status of the customer as a new or existing client of the financial institution. For the second row of results, if the first entity fails the Shared Fraud evaluation and if the customer is a new client of the financial institution (i.e., the customer is not an existing client) then the overall outcome is “fail”. For the third row of results, if the first entity fails the identity verification evaluation (i.e., the score exceeds a predetermined threshold as discussed above) and if the customer is a new client, the overall outcome is “fail”. For the fourth row of results, if the first entity passes the Hot File, Shared Fraud, and identity verification evaluations and is a new client, the overall outcome is “pass”. For the fifth row of results, if the first entity is an existing client and passes the Hot File evaluation the overall outcome is “pass” regardless of the results of the Shared Fraud and identity verification evaluations. If there is a secondary or joint applicant, the secondary applicant (which may be the second entity) is also evaluated as described above for the first entity.

For table 1102, the outcomes for the first and second entity (listed as “primary” and “secondary”, respectively), for example, determined in table 1101 are then entered in the first two columns of table 1102, respectively, and an overall outcome is shown in the third column. As can be seen in table 1102, if either or both of the primary and secondary applicants “fail”, the overall outcome for the customer is “fail”. Only if both the primary and secondary applicants “pass” (as shown in the bottom row of table 1102) is the overall outcome for the customer “pass” (i.e., the customer can continue with the online retail account opening process).

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal thereof.

What we claim is:

1. A method of interfacing with a financial institution using a computer interface, the method comprising the computer-implemented steps of:
(a) receiving an interface request from a computer operated by a customer after the customer has reached, via a path through a computer network, a predetermined webpage on a computer system for the financial institution;
(b) receiving at the webpage for the financial institution identification information from the customer;
(c) authenticating the customer at the financial institution based at least in part on an evaluation of a predetermined client identification profile (“CIP”), wherein the CIP is based at least in part on information internal to the financial institution;
(d) receiving from the customer information identifying a first and a second entity for the customer, wherein at least one of the first or second entity is an existing client of the financial institution;
(e) determining, using the first processor, if the customer passes the authentication and if not stopping the interfacing procedure;
(f) evaluating, using the first processor, the first entity against a first fraud factor and the financial institution stopping the interfacing procedure if the first entity does not pass the first fraud factor analysis;
(g) evaluating, using the first processor, the first entity against a second fraud factor and if the first entity does not pass the second fraud factor analysis determining, using a second processor on the computer system, if the first entity is an existing client of the financial institution and if so, continuing with the interfacing procedure, and if the first entity is not an existing client of the financial institution then stopping the interfacing procedure, wherein the second processor is operably connected to a database which includes information identifying existing clients of the financial institution;
(h) evaluating, using the first processor, the second entity against the first fraud factor and the financial institution stopping the interfacing procedure if the second entity does not pass the first fraud factor analysis;
(i) evaluating, using the first processor, the second entity against the second fraud factor and if the second entity does not pass the second fraud factor analysis determining, using the second processor, if the second entity is an existing client of the financial institution and if so, continuing with the interfacing procedure, and if the second entity is not an existing client of the financial institution then stopping the interfacing procedure, wherein the second processor is operably connected to the database which includes information identifying existing clients of the financial institution;
(j) comparing, using the first processor, an identity verification score for the first entity against a first predetermined threshold, wherein:
(A) if the identity verification score comparison for the first entity passes, continuing on to step (k); and
(B) if the identify verification score comparison for the first entity fails, determining, using the second processor, if the first entity is an existing client of the financial institution and if so, continuing on to step (k), and if the first entity is not an existing client of the financial institution, stopping the interfacing procedure, wherein the second processor is operably connected to the database which includes information identifying existing clients of the financial institution;
(k) comparing, using the first processor, an identity verification score for the second entity against the first predetermined threshold, wherein:
(A) if the identity verification score comparison for the second entity passes, continuing on to step (l); and
(B) if the identify verification score comparison for the second entity fails, determining, using the second processor, if the second entity is an existing client of the financial institution and if so, continuing on to step (1), and if the second entity is not an existing client of the financial institution, stopping the interfacing procedure;
(l) performing an account approval process, and
(m) transmitting a notification from the computer system to the customer regarding the account approval process.

2. The method of claim 1 wherein the first entity is a sole or primary applicant associated with the customer and the second entity is a secondary or joint applicant associated with the customer.

3. The method of claim 1 wherein the first fraud factor is a list comprising known fraudsters identified by the financial institution and the second fraud factor is a database of known fraudsters or abusers identified by the financial institution or a second financial institution.

4. The method of claim 3 wherein the first and second thresholds are different.

5. The method of claim 1, wherein the interface request received from the customer is a retail account opening request.

6. The method of claim 1, wherein the CIP consists of information unique to the financial institution.

7. The method of claim 1, wherein the first and second processors are the same.

8. The method of claim 1, wherein the step of authenticating the customer at the financial institution further includes creating a new CIP for the customer.
